(19) United States
(12) Patent Application Publication
(10) Pub. No.: US 2010/0173742 A1
(43) Pub. Date: Jul. 8, 2010

(54) Epicyclic gearbox

(75) Inventor: Robin C.S. Chang, Taichung (TW)

Correspondence Address: CHARLES E. BAXLEY, ESQUIRE, 90 JOHN STREET, SUITE 309, NEW YORK, NY, 10038, US

(73) Assignee: Apex Dynamics, Inc.

(21) Appl. No.: 12/319,659

(22) Filed: Jan. 8, 2009

(51) Int. Cl. F16H 57/08

(52) U.S. Cl. 475/342

(57) ABSTRACT

An epicyclic gearbox includes a shell, a sun gear assembly and a planet gear assembly. The shell is in the form of a drum formed with plain teeth on an internal side. The sun gear assembly for operative connection to a motor, the sun gear assembly includes a sun gear formed with bevel teeth. The planet gear assembly includes a spider for operative connection to a passive device. The planet gears are supported on the spider. Each planet gear includes plain teeth for engagement with the plain teeth of the shell and bevel teeth for engagement with the bevel teeth of the sun gear.

### FIELD OF INVENTION

The present invention relates to an epicyclic gearbox and, more particularly, to a quiet, precise, reliable and durable epicyclic gearbox in which a rear gap is automatically confined in an acceptable range.

### BACKGROUND OF INVENTION

A motor is used to drive a passive device and operated at a high rotational speed. If the motor is directly connected to the passive device, the device will be operated at an excessively high speed and inertia and a low torque. The structure of the passive device might be damaged, and the life reduced. Hence, it is a common practice to provide a reduction device between the motor and the passive device. A reduction device may include combination of a pinion with a gear. The combination of the pinion with the gear however entails loud noise strong vibration. To avoid noise and vibration, a reduction device may be an epicyclic gearbox such as disclosed in U.S. Pat. No. 5,687,480.

Referring to FIGS. 1 and 2, a conventional epicyclic gearbox includes a shell 10, a planet gear assembly 20 and a sun gear assembly 30. The shell 10 is in the form of a drum, and includes plain teeth on an internal side. The planet gear assembly 20 includes planet gears 21 mounted on a spider. Each planet gear 21 includes plain teeth thereon. The sun gear assembly 30 includes a sun gear 31 that includes plain teeth. Some plain teeth of each planet gear 21 are engaged with some plain teeth of the shell 10 at a nip A, and some other plain teeth of the planet gear 21 are engaged with some plain teeth of the sun gear 31 at a nip B. The sun gear 31 is connected to a motor while the spider is connected to a passive device. The motor drives the sun gear 31. The sun gear 31 drives the planet gears 21. The planet gears 21 drive the spider. The spider drives the passive device. Thus, the passive device is operated at a proper speed.

There is however a problem related to a too big or small rear gap during assembly of the planet gears 21 with the sun gear 31 because of tolerances in fabrication. It requires repeated calibration and alignment to assemble the planet gears 21 with the sun gear 31 with a proper rear gap. It takes a lot of time to achieve a proper rear gap. It is difficult and sometimes impossible to achieve an optimal rear gap. Therefore, the performance and life of the epicyclic gearbox will be jeopardized.

Moreover, each planet gear 21 includes some plain teeth engaged with some plain teeth of the shell 10 and some other plain teeth engaged with some plain teeth of the sun gear 31. The load on the planet gears 21 is heavier than the load on the shell 10 or the sun gear 31. The planet gears 21 will be worn away faster than the shell 10 or the sun gear 31. Once the planet gears 21 are worn away, the rear gap will be increased so that the planet gears 21 will not be properly engaged with the shell 10 or the sun gear 31. Therefore, there will be loud noise and strong vibration in the operation of the epicyclic gearbox. Moreover, the shell 10 or the sun gear 31 will be worn away faster than expected.

The present invention is therefore intended to obviate or at least alleviate the problems encountered in prior art.

### SUMMARY OF INVENTION

It is the primary objective of the present invention to provide a quiet, precise, reliable and durable epicyclic gearbox.

To achieve the foregoing objective, the epicyclic gearbox includes a shell, a sun gear assembly and a planet gear assembly. The shell is in the form of a drum formed with plain teeth on an internal side. The sun gear assembly for operative connection to a motor, the sun gear assembly includes a sun gear formed with bevel teeth. The planet gear assembly includes a spider for operative connection to a passive device. The planet gears are supported on the spider. Each planet gear includes plain teeth for engagement with the plain teeth of the shell and bevel teeth for engagement with the bevel teeth of the sun gear. Due to the engagement of the bevel teeth of the planet gears with the bevel teeth of the sun gear, a rear gap is automatically confined in an acceptable range.

Other objectives, advantages and features of the present invention will become apparent from the following description referring to the attached drawings.

### BRIEF DESCRIPTION OF DRAWINGS

The present invention will be described via detailed illustration of two embodiments versus the prior art referring to the drawings.

FIG. 1 is a front view of a conventional epicyclic gearbox.

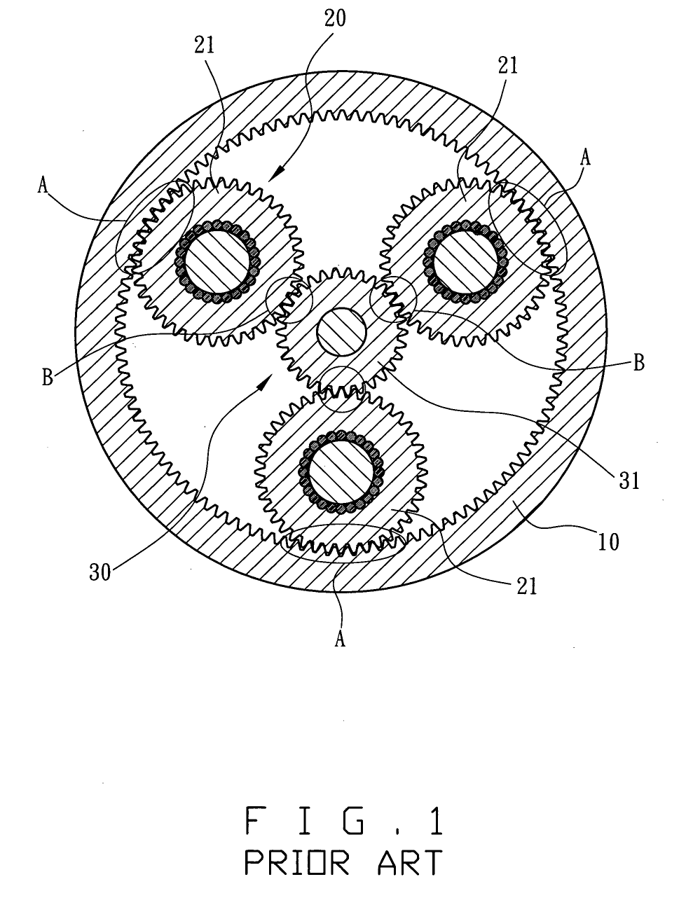

FIG. 2 is another cross-sectional view of the conventional epicyclic gearbox shown in FIG. 1.

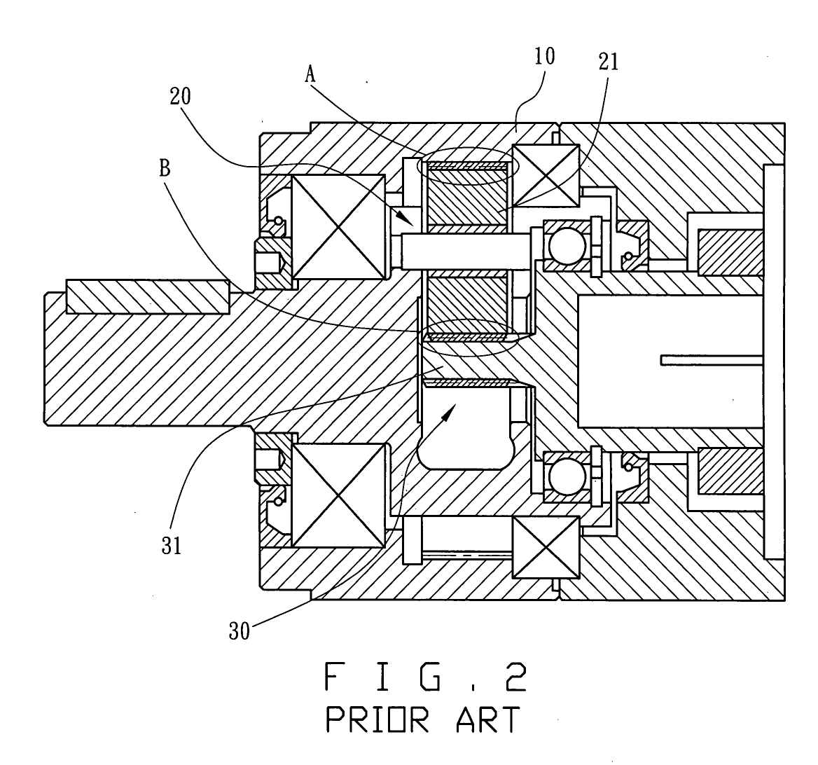

FIG. 3 is a cross-sectional view of an epicyclic gearbox according to the first embodiment of the present invention.

FIG. 4 is a cross-sectional view of an epicyclic gearbox according to the second embodiment of the present invention.

### DETAILED DESCRIPTION OF EMBODIMENTS

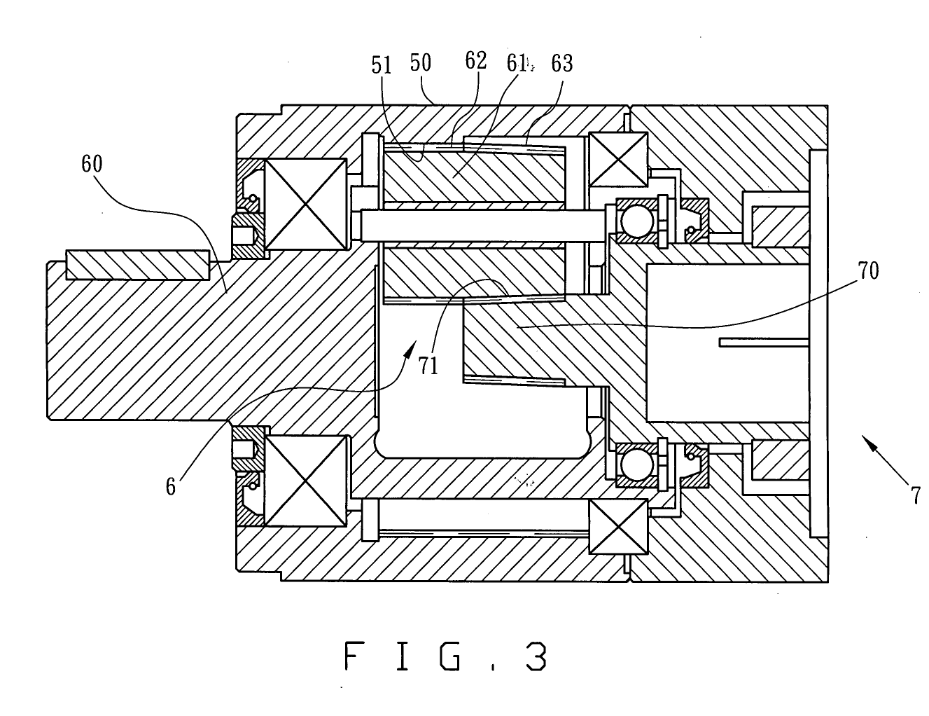

Referring to FIG. 3, an epicyclic gearbox includes a shell 50, a planet gear assembly 6 and a sun gear assembly 7 according to a first embodiment of the present invention.

The shell 50 is in the form of a drum, and includes plain teeth 51 on an internal side. The length of each plain tooth 51 is in parallel to the axis of the shell 50.

The planet gear assembly 6 includes a spider 60 for supporting planet gears 61. Each planet gear 61 includes plain teeth 62 on a section thereof and bevel teeth 63 on another section thereof. The length of each plain tooth 62 is in parallel to the axis of each planet gear 61. The length of each bevel tooth 63 is biased from the axis of each planet gear 61 by an angle of 1.5 to 3 degrees and, preferably, 2 degrees.

The sun gear assembly 7 includes a sun gear 70. The sun gear 70 includes bevel teeth 71 thereon. The length of each bevel tooth 71 is biased from the axis of the sun gear 70 by an angle of 1.5 to 3 degrees and, preferably, 2 degrees. The bevel teeth 71 of the sun gear 70 extend corresponding to the bevel teeth 63 of each planet gear 61 so that the former can be engaged with the latter.

Some plain teeth 62 of each planet gear 61 are engaged with some plain teeth 51 of the shell 50, and some bevel teeth 63 of the planet gear 61 are engaged with some bevel teeth 71 of the sun gear 70. In use, the sun gear 70 is connected to a motor while the spider 60 is connected to a passive device. The motor drives the sun gear 70. The sun gear 70 drives the planet gears 61. The planet gears 61 drive the spider 60. The spider 60 drives the passive device. Thus, the passive device is operated at a proper speed lower than that of the motor.

The present invention exhibits advantages over the prior art. A proper rear gap is automatically achieved due to the bevel teeth 63 engaged with the bevel teeth 71 although there are inevitably tolerances in fabrication of the components. There is no need for repeated calibration and alignment in assembly of the planet gears 21 with the sun gear 31. The proper rear gap is maintained throughout the life of the epicyclic gearbox because of the bevel teeth 63 engaged with the bevel teeth 71 although the components will inevitably be worn.

Moreover, each planet gear 61 uses the plain teeth 62 for engagement with the plain teeth 51 of the shell 50 and the bevel teeth 63 for engagement with the bevel teeth 71 of the star gear 70. The load on the planet gears 61 is not much heavier than the load on the shell 50 or the sun gear 71. The planet gears 61 will not be worn away much faster than the shell 10 or the sun gear 31.

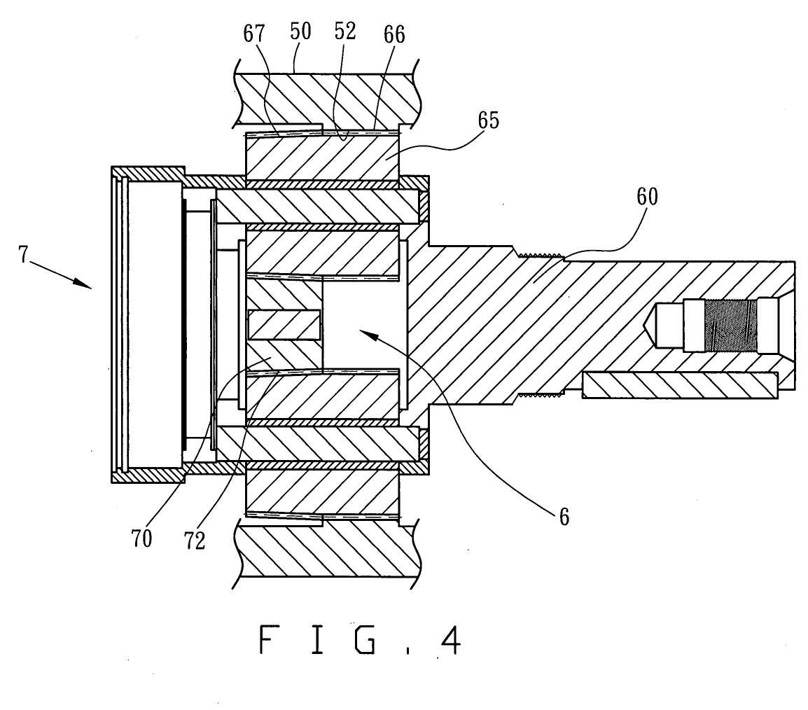

Referring to FIG. 4, there is shown an epicyclic gearbox according to a second embodiment of the present invention. The second embodiment is like the first embodiment except several features. Firstly, the planet gear assembly 6 includes planet gears 65 instead of the planet gears 61. Each planet gear 65 includes bevel teeth 66 and plain teeth 67. The bevel teeth 66 are like the bevel teeth 63. The plain teeth 67 are like the plain teeth 62. Secondly, the shell 50 includes bevel teeth 52 for engagement with the bevel teeth 66. Thirdly, the sun gear 71 includes plain teeth 72 for engagement with the plain teeth 67.

In another embodiment of the present invention, the shell 50 includes bevel teeth 52. The sun gear 70 includes bevel teeth 71. Each planet gear includes bevel teeth 66 for engagement with the bevel teeth 52 and other bevel teeth 63 for engagement with the bevel teeth 71.

In another embodiment of the present invention, each bevel tooth 63, 66, 52 or 71 includes a bent configuration. That is, each bevel tooth 63, 66, 52 or 71 includes a first bevel section and a second bevel section, with an angle between the first and second bevel sections.

The present invention has been described via the detailed illustration of the embodiments. Those skilled in the art can derive variations from the embodiments without departing from the scope of the present invention. Therefore, the embodiments shall not limit the scope of the present invention defined in the claims.

1. An epicyclic gearbox comprising:
a shell being in the form of a drum and comprising plain teeth on an internal side;
a sun gear assembly for operative connection to a motor, the sun gear assembly comprising a sun gear formed with bevel teeth; and
a planet gear assembly comprising:
a spider for operative connection to a passive device; and
planet gears supported on the spider and each formed with plain teeth for engagement with the plain teeth of the shell and bevel teeth for engagement with the bevel teeth of the sun gear.

2. The epicyclic gearbox according to claim 1, wherein the length of each bevel tooth of each planet gear is biased from the axis of the planet gear by an angle of 1.5 to 3 degrees, and the length of each bevel teeth of the sun gear is biased from the axis of the sun gear by an angle of 1.5 to 3 degrees.

3. The epicyclic gearbox according to claim 2, wherein the angles are 2 degrees.

4. An epicyclic gearbox comprising:
a shell being in the form of a drum and comprising bevel teeth on an internal side;
a sun gear assembly for operative connection to a motor, the sun gear assembly comprising a sun gear formed with plain teeth; and
a planet gear assembly comprising:
a spider for operative connection to a passive device; and
planet gears supported on the spider and each formed with plain teeth for engagement with the plain teeth of the sun gear and bevel teeth for engagement with the bevel teeth of the shell.

5. The epicyclic gearbox according to claim 4, wherein the length of each bevel tooth of each planet gear is biased from the axis of the planet gear by an angle of 1.5 to 3 degrees, and the length of each bevel teeth of the shell is biased from the axis of the shell by an angle of 1.5 to 3 degrees.

6. The epicyclic gearbox according to claim 5, wherein the angles are 2 degrees.

7. An epicyclic gearbox comprising:
a shell being in the form of a drum and comprising bevel teeth on an internal side;
a sun gear assembly for operative connection to a motor, the sun gear assembly comprising a sun gear formed with bevel teeth; and
a planet gear assembly comprising:
a spider for operative connection to a passive device; and
planet gears supported on the spider and each formed with a first group of bevel teeth for engagement with the bevel teeth of the shell and a second group of bevel teeth for engagement with the bevel teeth of the sun gear.
